(19) United States
(12) Patent Application Publication
(10) Pub. No.: US 2015/0332401 A1
(43) Pub. Date: Nov. 19, 2015

(54) PERFORMANCE ATTRIBUTION FOR AN INVESTMENT FUND

(71) Applicant: Transamerica Corporation, San Francisco, CA (US)

(72) Inventors: Todd Porter, Lake Bluff, IL (US); Maciej Kowara, Downers Grove, IL (US); Nazar Suschko, Glenview, IL (US)

(73) Assignee: Transamerica Corporation, San Francisco, CA (US)

(21) Appl. No.: 14/276,432

(22) Filed: May 13, 2014

(51) Int. Cl. G06Q 40/06

(52) U.S. Cl. CPC G06Q 40/06

(57) ABSTRACT

Methods and apparatuses, including computer program products, are described for performance attribution for an investment fund. A server determines a selected asset allocation for a primary investment fund based upon a manager-selected weight and asset class exposures. The server determines a first rate of return based upon the selected asset allocation. The server generates a comparison investment fund. The server determines a second rate of return for the comparison investment fund. The server compares the second rate of return and a third rate of return for the primary investment fund to generate a fund selection contribution value. The server compares the first rate of return and the second rate of return to generate an opportunity set contribution value. The server determines a level of performance attributable to a manager of the primary investment fund based upon the fund selection contribution value and the opportunity set contribution value.

### FIELD OF THE INVENTION

This application relates generally to methods and apparatuses, including computer program products, for performance attribution for an investment fund.

### BACKGROUND

The subject matter of this application relates to performance attribution for any investment portfolio that is comprised of underlying managed investments. Throughout this application, we will refer to “fund of funds” and “fund of fund managers” for ease of exposition, but in all cases the reference should be interpreted to relate to any situation in which an investment manager or advisor is combining a group of managed investment products (underlying funds) from a broader lineup into an investment portfolio. This portfolio is referred to as the “primary fund” throughout the application. The primary fund could be a registered mutual fund, a collective trust, a variable insurance fund, an ETF, or a separate account. The term “underlying fund or asset” refers to the managed investments that together constitute the primary fund, and which could be registered mutual funds, collective trusts, variable insurance portfolios, ETFs, separate accounts, or any combination thereof.

The investment management situations to which the performance attribution methodology described herein is relevant therefore include, but are not limited to, the manager of a fund of funds; a consultant or advisor creating a model portfolio within a retirement plan, pension plan, or variable annuity; or a financial advisor or broker creating a portfolio from the available set of investment choices on a select or approved list. In each case, the key element of the investment process is that the manager is combining a group of underlying investments together to form a portfolio, and the group of underlying investments from which the manager is selecting is pre-defined.

Attribution analysis seeks to answer the question of what the sources of an investment manager's out- or under-performance were relative to a benchmark. In its typical current usage for a single equity fund, attribution analysis provides an answer such as: “This US large cap manager added value through the overweight of the technology sector stocks, but within the technology sector an underweight of stock XYZ detracted from performance.” Attribution analysis thus generally requires a pre-defined set of investment weights assigned to the choices in the available investment universe, which is typically defined as a portfolio-based benchmark. In the case of equity mutual funds, a typical portfolio benchmark for attribution analysis might be the S&P 500 Index. In attribution analysis it is these portfolio benchmark weights that serve as the neutral allocation against which a manager's choices are measured.

However, asset allocation fund of funds typically do not have a pre-defined portfolio benchmark and thus there are no neutral weights against which the manager's choices are measured. In addition, a fund of fund's manager (or an advisor building a portfolio of funds for a client) typically has a customized and constrained roster of investment options, also called the opportunity set. For example, a 401k plan lineup may have 20 funds; a variable annuity lineup may have 50 to 100 funds; a home office select list might have 200 funds; and a target-date retirement fund might be limited to only funds that are available from a particular fund family. This opportunity set is often not under the control of the fund of funds manager, but nevertheless can have a real and significant effect on the performance of the fund of funds.

There are effectively two choices required for an underlying fund to be a component of the fund of funds. First, a fund is included in the opportunity set, and then from that opportunity set, the fund of funds manager selects the fund and determines a weight for the fund. Because there are two choices, potentially from two different decision-makers, there are two fund selection contributions to differentiate in the attribution analysis: the contribution from the opportunity set decision, which measures the overall performance of all the choices in the lineup; and the contribution from fund selection, which measures the performance added or subtracted by the actual choices of the fund of funds manager.

While fund of fund managers do not have a portfolio benchmark, they typically do have a policy benchmark that guides their asset allocation, and which also serves as a general performance benchmark. A typical asset-allocation policy benchmark states that the fund of funds aims at achieving, for example, a 60/40% split between stocks and bonds on average over time. In this case, the manager's performance is likely judged against a blended performance benchmark, consisting of, e.g., 60% of the S&P 500 Index and 40% of the BarCap Aggregate bond index.

From such a policy benchmark, it is possible to calculate an asset allocation contribution. For example, if the manager chooses to invest 70% in funds that provide exposure comparable to the S&P 500, rather than 60%, and the S&P 500 had higher performance then the BarCap Aggregate, then the manager would have added value relative to the blended benchmark. In this case, it is possible to define the residual between the fund of fund's actual performance and the performance contributed from its asset allocation as the combined contribution from fund selection and the opportunity set. However, it is not possible to differentiate between the opportunity set contribution and the fund selection contribution, i.e. to determine how much was due to the selection of the lineup and how much was due to the manager's selection of the funds in the fund of funds.

The policy or performance benchmark indices cannot serve as a portfolio benchmark for the purposes of attribution analysis, because the fund of funds manager's investable universe is not the individual equity securities that make up the S&P 500, but rather a set of mutual funds or other managed-investment vehicles. Simply stated, a fund of fund manager does not pick securities, she picks funds; the manager's potential exposure to US large-cap stocks is mediated through the actively managed funds she has at her disposal. And therefore, to assess the quality of a fund of funds manager's fund selections, it is necessary to have a portfolio benchmark comprised of weights in the investable universe from which the fund of fund manager can choose. Currently, there are no such readily available portfolio benchmarks.

If each fund in the manager's investable universe provided pure exposure to asset classes and investment styles, then it would be relatively simple to assign each underlying fund to an asset class and then to assign a benchmark weight to the collection of funds providing exposure to that asset class. If a manager had a 10% policy benchmark weight in domestic large growth stocks, and there were 10 funds in her investable universe that provided pure exposure to domestic large growth stocks, then each of those funds could represent a 1% weight in the manager's custom fund of fund's portfolio benchmark.

However, there are virtually no pure managed products, if only for the simple reason that every manager holds some amount of cash in order meet redemptions and facilitate transactions. But more importantly, no equity fund manager has a pure equity portfolio. For example, the majority of domestic large growth equity managers also periodically have exposure to international equity, mid-cap equity, and core equity. As an illustration of this point, among the 465 distinct funds in Morningstar's U.S. Large Growth category, the purest fund has 90.5% exposure to domestic large growth stocks as defined by Morningstar. The median fund in the category has just 49.5% exposure to domestic large growth stocks. That fund's other exposures include 4% in cash, 4% in international stocks, 15% in value stocks, 15% in mid- and small-cap stocks, and nearly 20% in core stocks.

When a fund of fund manager allocates to such a fund, she is getting exposure to multiple asset classes, and thereby affecting multiple targets, which can greatly complicate the fund of fund manager's decision process. An additional factor that adds to the complexity of the decision process is the limited number of choices in the opportunity set. With a limited number of funds, there may not be sufficient choices for the fund of fund manager to hit her desired targets. Moreover, the fund of funds manager will typically have views on the skills of the underlying fund managers and will seek to overweight those that she believes may add the most value. In a situation where the fund of fund manager had the benefit of choosing from a set of high performing underlying funds, it may well be that strong performance of the fund of funds had little to do with the manager's choices. She merely benefited from the luck of having strong underlying funds. However, if the manager had to choose from a lineup in which most of the funds performed poorly, it may be the case that the fund of funds manager should be given great credit, even if the fund of funds also performed poorly, because she may have made the best choices possible from a set of weak underlying funds.

### SUMMARY OF THE INVENTION

Therefore, what is needed are methods and systems to create a set of pre-defined neutral investment fund benchmark weights that are consistent with the manager's selected asset allocation for the primary investment fund, and then to measure the manager's fund selection decisions against that benchmark, as well as the performance of that benchmark relative to the policy asset allocation. The benchmark weights may be selected to be neutral in the sense that they include no information about the underlying manager's performance or skill. However, construction of the benchmark does require information on the underlying fund's assets. This benchmark is referred to as the comparison investment fund, and is generated by an optimization module and algorithm that determines a weight for each asset in the opportunity set of eligible assets so as to spread the comparison investment fund's exposures as broadly as possible, consistent with the manager's selected asset allocation.

Such a comparison fund would be a maximum entropy or maximum diversification comparison because they reflect no information regarding the underlying fund's performance or characteristics. However, in the circumstance where the manager was instructed to give particular weight to a specific fund characteristic in building the portfolio, e.g. low expenses, low risk, or high risk-adjusted performance, then the comparison fund can be optimized around this goal. The only additional requirement is that information about that specific goal must be available for all the funds in the lineup. In this case, the comparison fund would no longer be the maximum diversification comparison fund, but instead would be the minimum expense comparison fund.

Given the comparison fund, and the policy asset allocation which specifies the primary investment fund's target allocations, one can measure the sources of the primary fund's out- or under-performance, which naturally fall into three categories:
The asset allocation contribution: Did the manager's decision to, for example, increase the weight of emerging-markets equities compared to its policy benchmark, add value?
The opportunity set contribution: Given the asset allocation decision made by the manager, how good a performance could have been typically expected given the lineup of funds available to the manager?
The fund selection contribution: How much value did the manager's fund selections add or subtract, compared to the previously determined fund-lineup quality available to the manager?

The invention, in one aspect, features a computerized method for performance attribution for an investment fund. A server computing device determines a selected asset allocation for a primary investment fund based upon a manager-selected weight assigned to each asset in the primary investment fund and asset class exposures assigned to each asset in the primary investment fund, the assets in the primary investment fund selected from a set of eligible assets. The server computing device determines a first rate of return for the primary investment fund based upon the selected asset allocation. The server computing device generates a comparison investment fund, where the comparison investment fund is comprised of assets from the set of eligible assets, an asset allocation for the comparison investment fund conforms to the selected asset allocation for the primary investment fund, and the comparison investment fund includes a weight assigned to each asset. The server computing device determines a second rate of return for the comparison investment fund based upon returns of each asset in the set of eligible assets. The server computing device compares the second rate of return and a third rate of return for the primary investment fund based upon an actual return of the primary investment fund to generate a fund selection contribution value. The server computing device compares the first rate of return and the second rate of return to generate an opportunity set contribution value. The server computing device determines a level of performance attributable to a manager of the primary investment fund based upon the fund selection contribution value and the opportunity set contribution value.

The invention, in another aspect, features a system for performance attribution for an investment fund. The system includes a server computing device configured to determine a selected asset allocation for a primary investment fund based upon a manager-selected weight assigned to each asset in the primary investment fund and asset class exposures assigned to each asset in the primary investment fund, the assets in the primary investment fund selected from a set of eligible assets. The server computing device is configured to determine a first rate of return for the primary investment fund based upon the selected asset allocation. The server computing device is configured to generate a comparison investment fund, where the comparison investment fund is comprised of assets from the set of eligible assets, an asset allocation for the comparison investment fund conforms to the selected asset allocation for the primary investment fund, and the comparison investment fund includes a weight assigned to each asset. The server computing device is configured to determine a second rate of return for the comparison investment fund based upon returns of each asset in the set of eligible assets. The server computing device is configured to compare the second rate of return and a third rate of return for the primary investment fund based upon an actual return of the primary investment fund to generate a fund selection contribution value. The server computing device is configured to compare the first rate of return and the second rate of return to generate an opportunity set contribution value. The server computing device is configured to determine a level of performance attributable to a manager of the primary investment fund based upon the fund selection contribution value and the opportunity set contribution value.

The invention, in another aspect, features a computer program product, tangibly embodied in a non-transitory computer readable storage device, for performance attribution for an investment fund. The computer program product includes instructions operable to cause a server computing device to determine a selected asset allocation for a primary investment fund based upon a manager-selected weight assigned to each asset in the primary investment fund and asset class exposures assigned to each asset in the primary investment fund, the assets in the primary investment fund selected from a set of eligible assets. The computer program product includes instructions operable to cause the server computing device to determine a first rate of return for the primary investment fund based upon the selected asset allocation. The computer program product includes instructions operable to cause the server computing device to generate a comparison investment fund, where the comparison investment fund is comprised of assets from the set of eligible assets, an asset allocation for the comparison investment fund conforms to the selected asset allocation for the primary investment fund, and the comparison investment fund includes a weight assigned to each asset. The computer program product includes instructions operable to cause the server computing device to determine a second rate of return for the comparison investment fund based upon returns of each asset in the set of eligible assets. The computer program product includes instructions operable to cause the server computing device to compare the second rate of return and a third rate of return for the primary investment fund based upon an actual return of the primary investment fund to generate a fund selection contribution value. The computer program product includes instructions operable to cause the server computing device to compare the first rate of return and the second rate of return to generate an opportunity set contribution value. The computer program product includes instructions operable to cause the server computing device to determine a level of performance attributable to a manager of the primary investment fund based upon the fund selection contribution value and the opportunity set contribution value.

Any of the above aspects can include one or more of the following features. In some embodiments, the step of determining a first rate of return for the primary investment fund is based upon a benchmark return value. In some embodiments, the benchmark return value is based upon returns associated with one or more market indices.

In some embodiments, the server computing device determines a fourth rate of return for the primary investment fund based upon the benchmark return value and an asset allocation policy associated with the primary investment fund and determines an asset allocation contribution value based upon the first rate of return and the fourth rate of return. In some embodiments, the level of performance attributable to a manager of the primary investment fund is further based upon the asset allocation contribution value. In some embodiments, the asset allocation contribution value, the fund selection contribution value and the opportunity set contribution value are added together to arrive at the level of performance.

In some embodiments, the opportunity set contribution value is used to determine which assets are included in the primary investment fund for future periods of time. In some embodiments, the level of performance represents a decreased rate of return of the primary investment fund that is attributable to the manager of the primary investment fund. In some embodiments, the asset allocation for the comparison investment fund conforms to the selected asset allocation for the primary investment fund if the asset allocation for the comparison investment fund is within a predetermined tolerance of the selected asset allocation for the primary investment fund.

In some embodiments, the server computing device transmits a notice including the level of performance to a remote computing device associated with the manager of the primary investment fund. In some embodiments, the notice is transmitted to a remote computing device associated with a manager of the manager of the primary investment fund.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for performance attribution for an investment fund.

FIG. 2 is a flow diagram of a method for performance attribution for an investment fund.

FIG. 3 is a detailed flow diagram of a method for performance attribution for an investment fund.

FIG. 4 is a table representing an exemplary benchmark for an investment fund, including component index returns.

FIG. 5 is a table representing a roster (or opportunity set) of assets available for inclusion in the investment fund, including manager-selected weights and underlying returns for each asset.

FIG. 6 is a table representing the selected (or effective) asset allocation of the investment fund, based upon the table in FIG. 5.

FIG. 7 is a table representing the roster of assets from FIG. 5, including a maximum entropy weight assigned to each asset in the comparison investment fund.

FIG. 8 is a table comparing the selected (or effective) asset allocation of the investment fund from FIG. 6 with the asset allocation for the comparison investment fund.

FIG. 9 is a table depicting the total performance of the investment fund based upon the asset allocation contribution value, the opportunity set contribution value and the fund selection contribution value.

FIG. 10 is a block diagram of a networked system for performance attribution for an investment fund.

### DETAILED DESCRIPTION

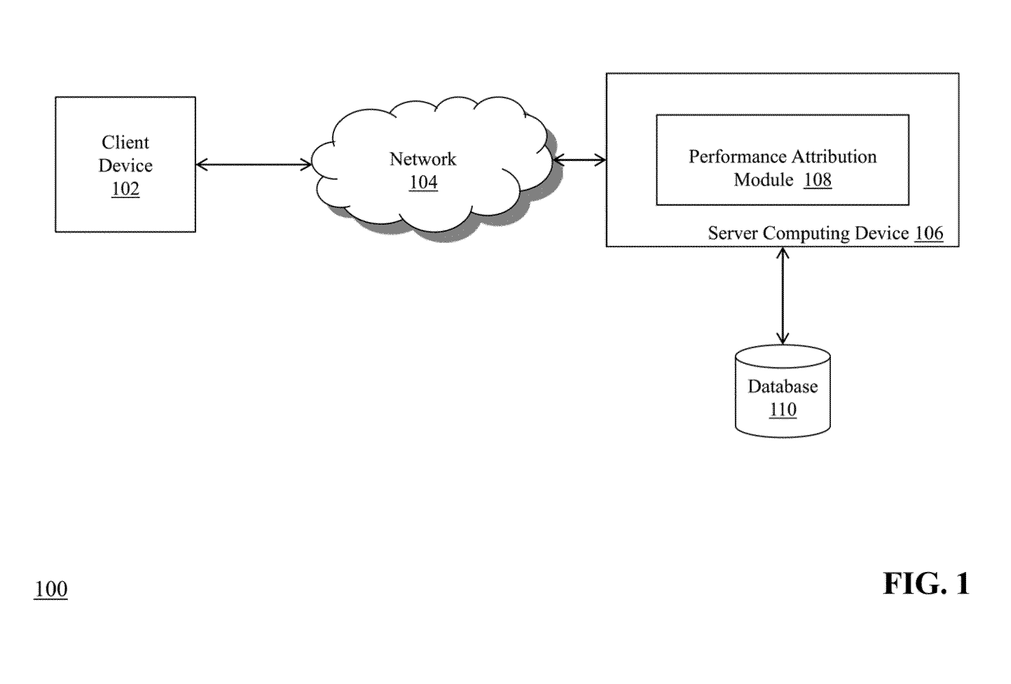

FIG. 1 is a block diagram of a system 100 for performance attribution for an investment fund, according to an embodiment of the invention. The system 100 includes a client computing device 102, a communications network 104, a server computing device 106 that includes a performance attribution module 108, and a database 110.

The client computing device 102 connect to the server computing device 106 via the communications network 104 in order to initiate the performance attribution process and receive corresponding results from the server computing device 106. Exemplary client devices include desktop computers, laptop computers, tablets, mobile devices, smartphones, and internet appliances. It should be appreciated that other types of computing devices that are capable of connecting to the server computing device 106 can be used without departing from the scope of invention. Although FIG. 1 depicts one client device 102, it should be appreciated that the system 100 can include any number of client devices.

The communication network 104 enables the client device 102 to communicate with the server computing device 106 in order to initiate the investment fund performance attribution process. The network 104 may be a local network, such as a LAN, or a wide area network, such as the Internet and/or a cellular network. In some embodiments, the network 104 is comprised of several discrete networks and/or sub-networks (e.g., cellular, Internet) that enable the client device 102 to communicate with the server computing device 106.

The server computing device 106 is a combination of hardware and software modules that perform the investment fund performance attribution process and transmit the results of the performance attribution process to remote computing devices (e.g., device 102). The server computing device 106 includes a performance attribution module 108. The module 108 is a hardware and/or software module that resides on the server computing device 106 to perform functions associated with collecting input data, performing computations and analyses, and returning output data relating to the performance attribution process. In some embodiments, the functionality of the module 108 is distributed among a plurality of computing devices. It should be appreciated that any number of computing devices, arranged in a variety of architectures, resources, and configurations (e.g., cluster computing, virtual computing, cloud computing) can be used without departing from the scope of the invention.

The system 100 also includes a database 110. The database 110 is coupled to the server computing device 106 and stores data used by the server computing device 106 to perform the investment fund performance attribution process. The database 110 can be integrated with the server computing device 106 or be located on a separate computing device.

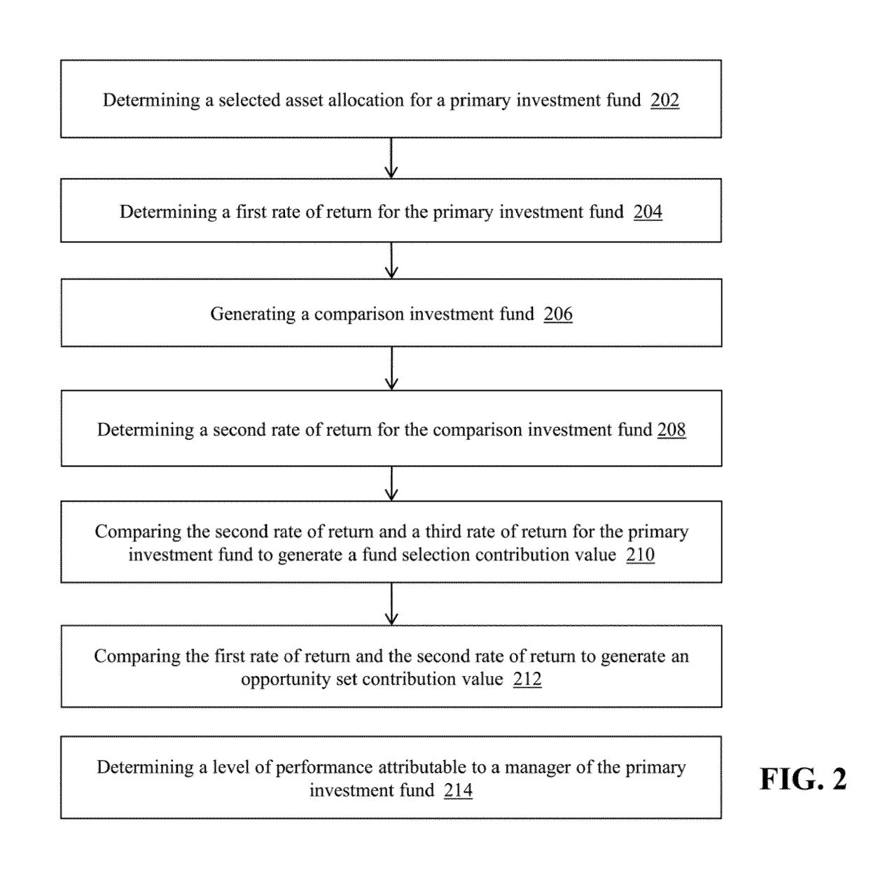

FIG. 2 is a flow diagram of a method for performance attribution for an investment fund, using the system 100 of FIG. 1. The performance attribution module 108 of the server computing device 106 receives a request to initiate a performance attribution determination for a particular manager-run investment fund (also called a primary investment fund). For example, a user can log into a web site using software on client device 102 and, e.g., press a button to initiate the performance attribution process. The client device 102 then transmits the initiation request to the server computing device 106.

It should be appreciated that the primary investment fund can be comprised of any number of assets (e.g., stocks, bonds, mutual funds, other types of financial instruments or vehicles) without departing from the scope of invention. For example, the primary investment fund can be a fund of funds that is comprised of individual investment funds.

The performance attribution module 108 determines (202) a selected asset allocation for the primary investment fund based upon (i) a manager-selected weight assigned to each asset in the primary investment fund and (ii) asset class exposures assigned to each asset in the primary investment fund. For example, a manager of an investment fund may choose specific assets from a roster of eligible assets for inclusion in the investment fund. The roster of eligible assets is also called the opportunity set, as the overall performance of the investment fund may be shaped by the roster of eligible assets that the manager is able to choose from.

Based upon the manager's selections, the performance attribution module 108 can assign weights to each asset in the roster in order to generate the selected asset allocation. For example, the performance attribution module 108 can assign a weight of 5% to a particular asset in the roster (meaning that the manager invested 5% of the available funds into that asset) and the module 108 can assign a weight of 0% to another asset in the roster (meaning that the manager decided not to invest any funds into that asset). Each asset in the primary investment fund also is associated with an asset class (e.g., equity, bond, cash, etc.), which corresponds to one or more asset class exposures assigned to each asset.

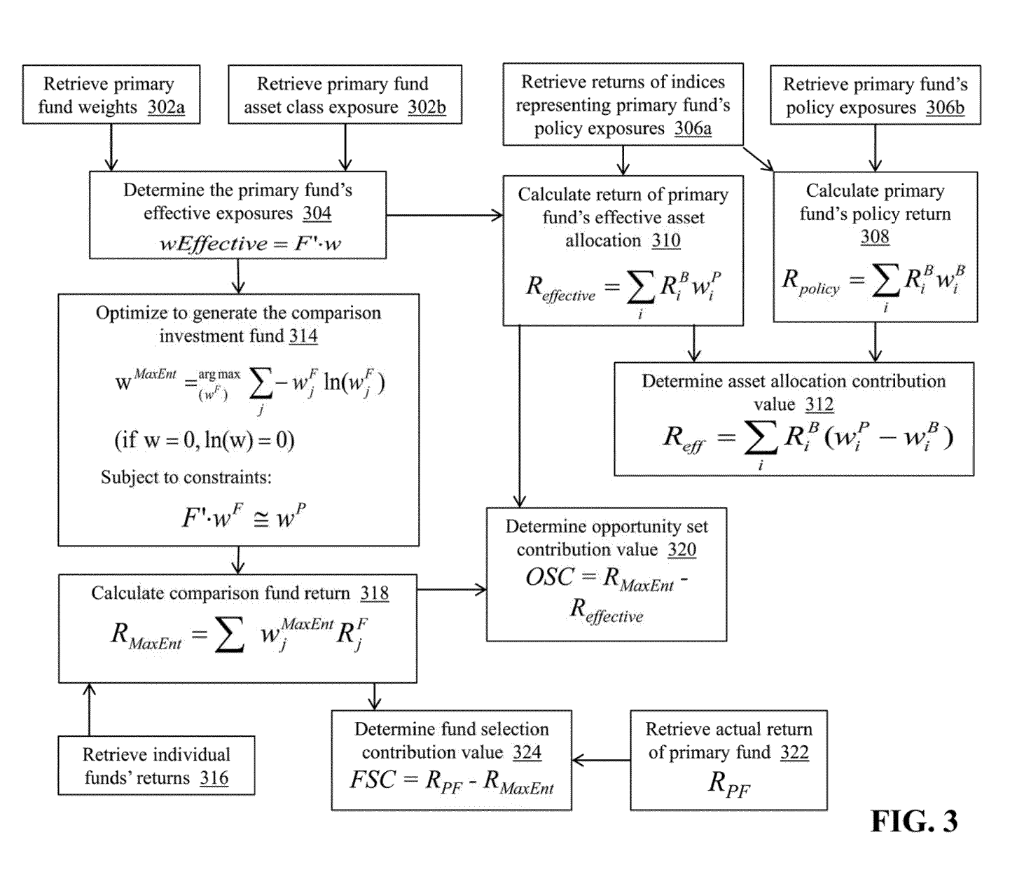

The performance attribution module 108 determines (204) a first rate of return for the primary investment fund based upon the selected asset allocation. As will be described in greater detail below with respect to FIG. 3, the performance attribution module 108 determines a rate of return that is attributable to the primary investment fund based upon the selected asset allocation. In some embodiments, the first rate of return is also based upon the returns of indices representing the investment fund's policy exposures.

The performance attribution module 108 generates (206) a comparison investment fund (also called a maximum entropy investment fund) that is comprised of assets from the set of eligible assets (i.e., the opportunity set). The asset allocation for the comparison investment fund conforms to the selected asset allocation for the primary investment fund, and the comparison investment fund includes a weight assigned to each asset.

The performance attribution module 108 determines (208) a second rate of return for the comparison investment fund based upon returns of each asset in the eligible set of assets. The performance attribution module 108 compares (210) the second rate of return and a third rate of return for the primary investment fund, which is based upon the actual return of the primary investment fund to generate a fund selection contribution value. The performance attribution module 108 compares (212) the first rate of return and the second rate of return to generate an opportunity set contribution value. The performance attribution module 108 determines (214) a level of performance attributable to a manager of the primary investment fund based upon the fund selection contribution value and the opportunity set contribution value.

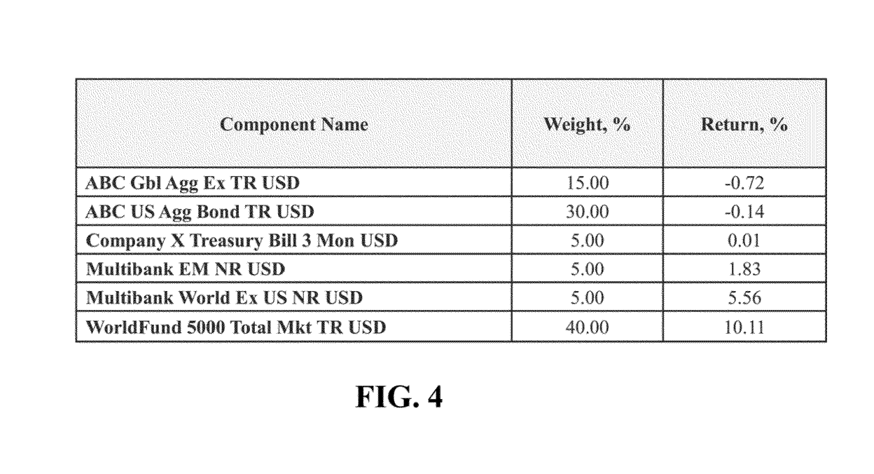

FIG. 3 is a detailed flow diagram of a method for performance attribution for an investment fund, using the system 100 of FIG. 1 and corresponding to the method of FIG. 2. Before describing FIG. 3 in detail, it should be noted that many investment funds (including fund of funds) have a policy benchmark that describes the required or optimal allocation for the assets that comprise the investment fund. FIG. 4 is a table representing an exemplary benchmark for an investment fund, including component index returns, for a particular time period (e.g., one month, one quarter, or one year). As shown in FIG. 4, a set of component assets is listed, each having a corresponding weight (by percentage) and a rate of return (by percentage). For example, the ABC Gbl Agg Ex TR USD asset has a weight of 15.00% and a rate of return of −0.72%. The benchmark of FIG. 4 amounts to a 4.26% rate of return for the period.

The benchmark depicted in FIG. 4 is a relatively simple blended benchmark for the sake of illustration. Real-life investment fund managers would likely use a benchmark with more resolution (one that includes e.g. large/smid, growth and value), but the principle remains unchanged regardless of the benchmark chosen.

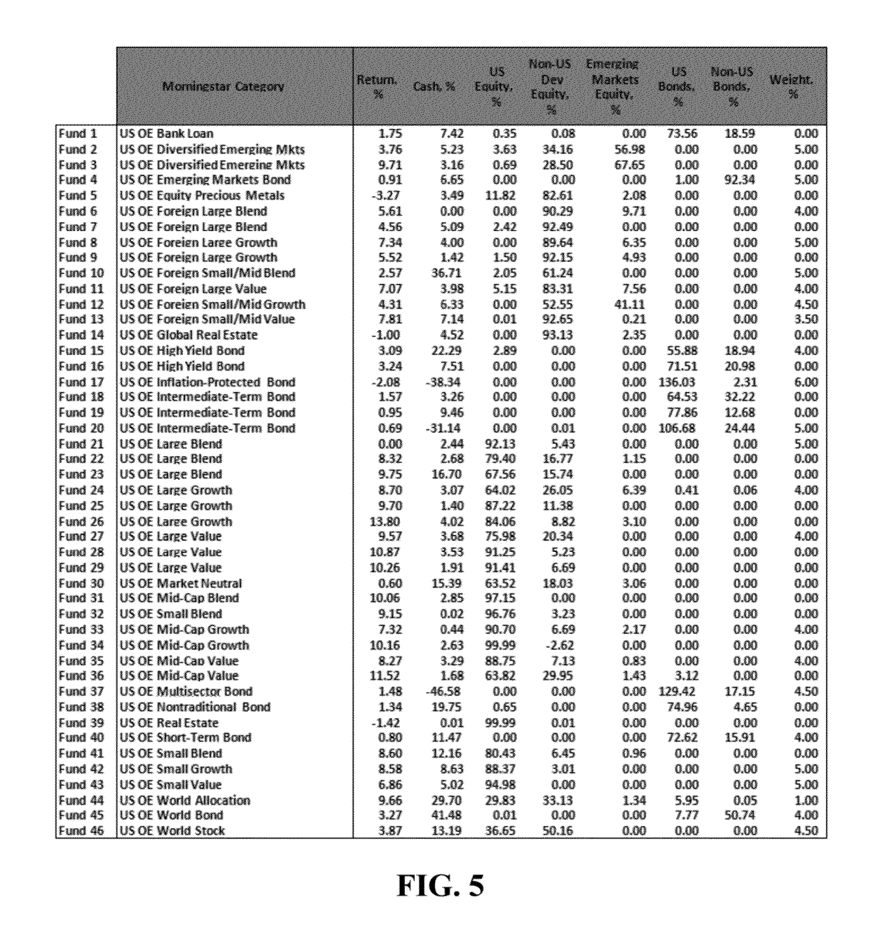

The policy benchmark can be a useful tool in determining the out- or under-performance of an investment fund when compared with the manager-selected assets and weights for the investment fund. FIG. 5 is a table representing a roster (or opportunity set) of eligible assets available for inclusion in the investment fund, including manager-selected weights and underlying returns for each asset. For example, Fund 1 has a return of 1.75% for the applicable period, and is comprised of the following exposures: 7.42% cash, 0.35% U.S. equity, 0.08% non-U.S. dev equity, 0.00% emerging markets equity, 73.56% U.S. bonds, and 18.59% non-U.S. bonds. Fund 1 is categorized as ‘US OE Bank Loan’ by the applicable investment research entity (here, Morningstar®). Fund 1 is shown as having a weight of 0.00% because the manager elected not to allocate any investment fund assets into Fund 1. Other assets/funds in the opportunity set are assigned a non-zero weight (e.g., Fund 2, Fund 15, etc.) because the manager selected those assets to be part of the primary investment fund.

It is assumed that the exposures listed in FIG. 5 (e.g., cash, U.S. equity, non-U.S. dev equity, emerging markets equity, U.S. bonds, non-US bonds) naturally map over to the indices listed in the benchmark in FIG. 4. From the number of funds and their asset-class coverage (i.e., Morningstar® category), this is a diversified lineup, which is not unusual—it is common for, e.g., funds of funds to have fifty or more underlying fund holdings.

Turning back to FIG. 3, the performance attribution module 108 retrieves (302a) the manager-assigned weights for each of the assets in the primary investment fund (as shown in the weight column of the table in FIG. 5). The performance attribution module 108 also retrieves (302b) the asset class exposures for the selected (or non-zero-weighted) assets in the primary investment fund (shown in the cash, U.S. equity, non-U.S. dev equity, emerging markets equity, U.S. bonds, and non-US bonds columns of FIG. 5).

Once the performance attribution module 108 has collected the manager-assigned weights and the asset class exposures for the selected assets, the performance attribution module 108 determines (304) the selected asset allocation (or effective exposures) for the primary investment fund. The performance attribution module 108 calculates the selected asset allocation using the following equation:

wEffective=F′·w

where F stands for the n×k matrix (n assets by k asset class exposures), w stands for the weights assigned to the assets, and ′ indicates a transpose.

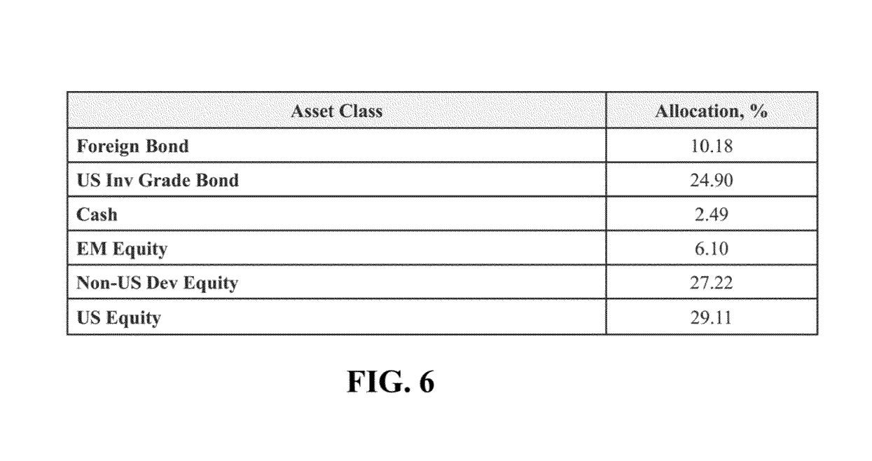

FIG. 6 is a table representing the selected (or effective) asset allocation of the investment fund, based upon the information in the table in FIG. 5. As shown in FIG. 6, the selected asset allocation is comprised of six asset classes, each with a corresponding allocation percentage. For example, the foreign bond asset class has an allocation percentage of 10.18%

Therefore, the rate of return of the primary investment fund (R_{PF}), given the weights and returns from FIG. 5, is 4.36%, while the benchmark's return as noted above is 4.26%. Thus, in this example, the primary investment fund outperformed its benchmark by 0.10%. As will be described next, the performance attribution module 108 performs further calculations to allocate the difference in performance into component parts that reflect the effects of the asset allocation decision, the quality of the opportunity set, and the manager's asset-choice decisions.

First, the performance attribution module 108 determines the contribution value of the asset allocation to the overall performance of the primary investment fund. The performance attribution module 108 retrieves (306a) returns of indices representing the primary investment fund's benchmark policy exposures (as depicted in the return column in FIG. 4). The performance attribution module 108 also retrieves (306b) the benchmark policy exposures (as depicted in the weight column in FIG. 4). The performance attribution module 108 calculates (308) the rate of return for the primary investment fund's benchmark policy using the following equation:

$${R}_{policy} = {\sum }_{i} {R}_{i}^{B} {w}_{i}^{B}$$

where Rᵢ^{B} is the return of benchmark/asset class i, which is the part of the composite policy benchmark, and the wᵢ^{B} are the weights of the asset class i in the benchmark (B). As set forth previously, the benchmark policy's rate of return is 4.26%.

The performance attribution module 108 also calculates (310) the rate of return of the primary investment fund's selected asset allocation using the following equation:

$${R}_{effective} = {\sum }_{i} {R}_{i}^{B} {w}_{i}^{P}$$

where Rᵢ^{B} is the return of benchmark/asset class i, which is the part of the composite policy benchmark, and the wᵢ^{P} are the manager-selected weights of the asset class i in the primary investment fund (P). Continuing with the above example, the rate of return of the primary investment fund's selected asset allocation is 4.46% (using weights from the table in FIG. 4 and asset returns equal to the index returns set forth in the table in FIG. 5).

Based upon the rate of return for the primary investment fund's benchmark policy (R_{policy}) and the rate of return of the primary investment fund's selected asset allocation (R_{effective}), the performance attribution module 108 determines (312) the asset allocation contribution value (R_{eff}) for the primary investment fund using the following algorithm:

$${R}_{eff} = {\sum }_{i} {R}_{i}^{B} ( {w}_{i}^{P} - {w}_{i}^{B} )$$

where Rᵢ^{B} is the return of benchmark/asset class i, which is the part of the composite benchmark, and the wᵢ are the weight of the asset class i in the benchmark (B) and the primary investment fund (P), respectively.

Therefore, the asset allocation contribution value is the difference between the rate of return of the primary investment fund's selected asset allocation (4.46%) and the rate of return for the primary investment fund's benchmark policy (4.26%)—or 0.20%. Therefore, the manager's decision to overweight non-US equities, mainly at the expense of domestic equities and foreign and domestic bonds, added value. The outperformance of 0.20% is more that 0.10% observed before. What accounts for the difference of ten basis points?

To determine the answer to this question, the performance attribution module 108 proceeds to generate (314) a comparison investment fund (also called the maximum entropy (MaxEnt) investment fund). The general approach is to evaluate the quality of the manager's asset choices in terms of a comparison investment fund that allows for the same effective asset allocation. In other words, the comparison investment fund is in some embodiments the maximally diversified investment fund that can be constructed conditional on having the same risk or factor exposures as the primary investment fund itself did. The effect of the manager's own fund selection then becomes a residual return.

It should be noted that, as described herein, the criteria for generating the comparison investment fund is to maximize diversity of assets in the fund. However, in some embodiments, maximum diversity is not the only criteria for constructing the comparison investment fund. The comparison investment fund should be based on an optimization subject to the constraint that the comparison fund matches the primary fund's asset allocation exposures, and that optimization can based on a variety of metrics, such as maximum entropy (e.g., if the manager has no information or requirements for any metrics), but if the manager has information on other characteristics or requirements, he or she can optimize the comparison investment fund based on the other characteristics or requirements, such as: minimum expenses; minimum risk measures such as volatility, downside risk, value at risk; or maximum Sharpe ratio.

For example, if a manager had been instructed by a client to be highly concerned with expenses, the comparison investment fund can be selected by the manager to minimize expenses—e.g., the manager would have expense information about the underlying assets in the investment fund. In this case, the manager is evaluated against the investment fund that best accomplished the client's goals. To the extent that the manager selected funds that did not minimize expenses, such a selection should be reflected in superior performance of the investment fund.

To justify the comparison investment fund, a manager who knew nothing of the quality of the underlying assets/funds, but knew only their asset class exposures, as shown in FIG. 5, and was tasked with creating an investment fund whose selected asset allocation corresponds to the allocation shown in FIG. 6, would try to get an investment fund that was maximally diversified, conditional on hitting the given effective asset allocation. Maximum entropy is a way to maximize diversification, subject to constraints that take the shape of the selected asset allocation. Entropy is in itself a measure of diversification or of uncertainty, and is defined as:

$$H = - {\sum }_{i = 1}^{N} {w}_{i} ln ( {w}_{i} )$$

where w stands for weights, with the understanding that if wᵢ=0 then wᵢ ln(wᵢ)=0. (Here, the weights are interpreted as probabilities, since the weights, if they are non-negative, satisfy probability-axioms requirements.)

A maximum entropy investment fund is a fund of maximum uncertainty, and a manager who knows nothing about how good the underlying assets/funds are would try to reflect maximum uncertainty, because the maximum entropy distribution is the distribution that correctly corresponds with the a maximal amount of uncertainty. It represents the only probability assignment that is maximally noncommittal with regard to missing information, i.e., that, while obeying the constraint, does not assume any information that is not available. Investment professionals may not be used to interpreting investment fund weights through the lens of entropy-measured uncertainty, but they are familiar with the concept of diversification, and the maximum entropy investment fund is the maximally diversified fund (in terms of weights) that satisfies a given set of constraints. Accordingly, “maximum entropy” could be replaced by “maximum diversification.” Thus, the natural benchmark for a manager to beat is a totally ignorant manager who constructs a fund subject to the same constraints.

The performance attribution module 108 generates the comparison investment fund using the following equation:

$${W}^{MaxEnt} = {argmax}_{( {w}^{F} )} {\sum }_{j} - {w}_{j}^{F} ln ( {w}_{j}^{F} )$$

$$( if w = 0 , ln ( w ) = 0 )$$

where w^{MaxEnt} is the vector of weights for the underlying assets in the comparison investment fund, in which optimization the vector of asset weights is constrained so that:

F′·w^{F}≅w^{P}

where F is the matrix of underlying assets' asset class exposures presented in FIG. 5 (the ′ indicates a transpose). The approximate equality sign is used because the asset class weights are allowed to stay within a narrow range of the selected asset allocations rather than forcing an absolute equality.

If a different objective function is used, e.g., to minimize fees, the relevant equation is (with fᵢ standing for fees of fund j):

$${w}^{MinFee} = {argmin}_{( {w}^{F} )} {\sum }_{j} {w}_{j}^{F} {f}_{j}$$

In some embodiments, the performance attribution module 108 uses an optimizer to generate the comparison investment fund. Examples of such an optimizer include the MatLab® global optimization toolbox and the Microsoft® Excel® Solver. In the above example, a 0.5% tolerance level was set and the optimizer generated a maximally diversified fund whose selected asset allocation is within plus or minus the tolerance level.

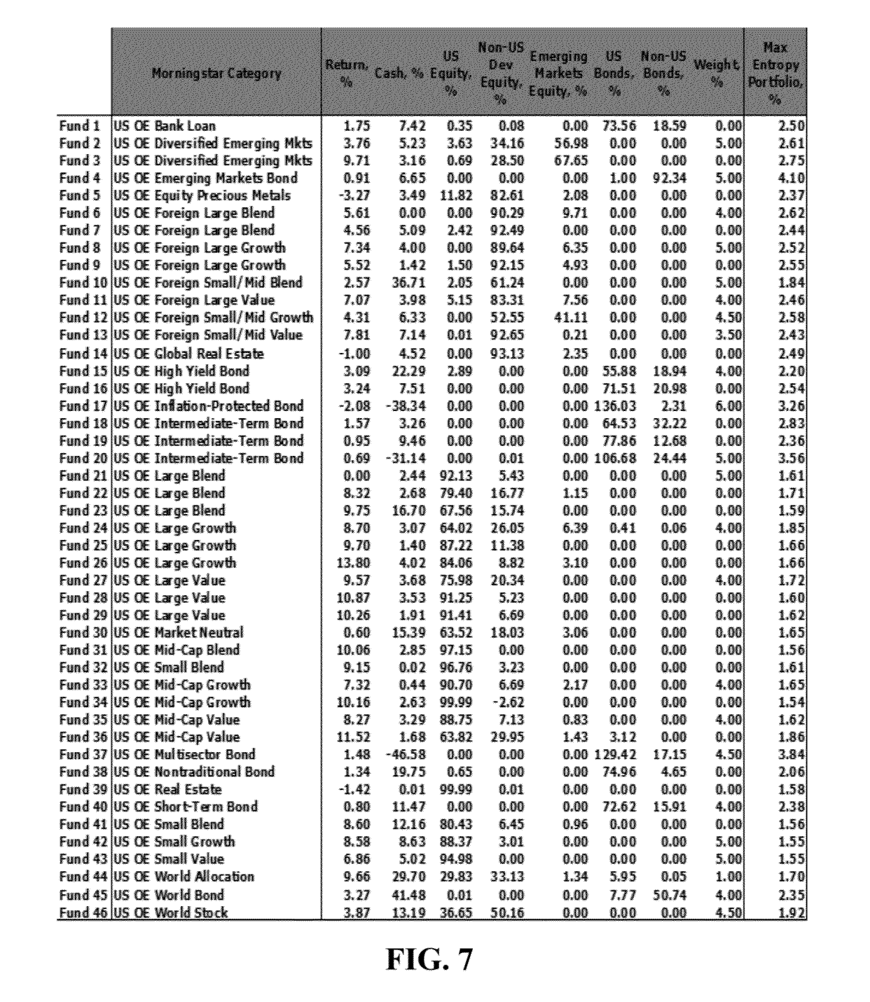

FIG. 7 is a table representing the roster of assets from FIG. 5, including a maximum entropy weight assigned by the performance attribution module 108 to each asset/fund in the comparison investment fund. As shown in FIG. 7, the right-most column in the table (under the heading of Maximum Entropy Portfolio) contains the weight assigned to each asset in the opportunity set for the comparison investment fund. When compared to the weight column in the same table (which represents the manager-selected weight for the primary investment fund), the maximum entropy weights are more diversified and cover a wider range of funds than the manager-selected weights.

The performance attribution module 108 retrieves (316) the returns for the individual assets in the opportunity set (see the Return column in the table in FIG. 7), and calculates a rate of return for the comparison investment fund using the following equation:

R_{MaxEnt}Σwⱼ^{MaxEnt}Rⱼ^{F}

where w^{P} and R^{P} are defined as before (the returns and weights of the effective asset-class allocations), while the vector of underlying asset weights w^{MaxEnt} is defined as set forth above. Using the values in FIG. 7, the rate of return for the exemplary comparison investment fund is 4.69%.

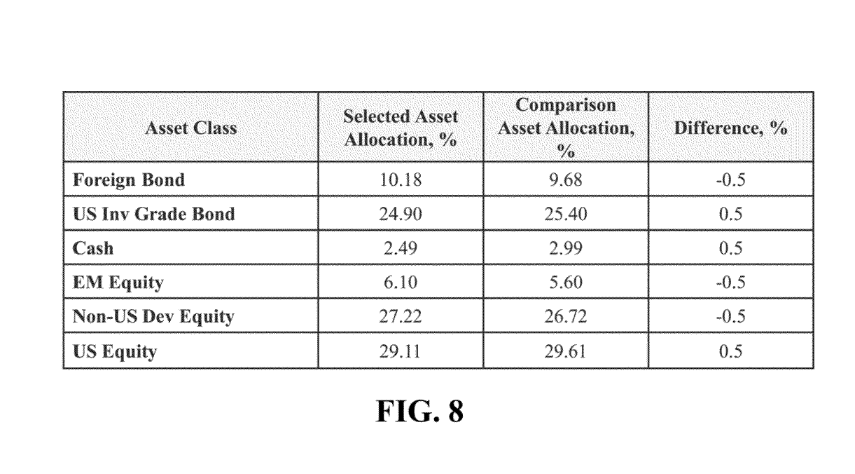

In some embodiments, the performance attribution module 108 checks that the asset allocation of the comparison investment fund is within the predetermined tolerance (i.e., 0.5%) of the selected asset allocation of the primary investment fund. FIG. 8 shows a table containing the selected asset allocation percentage for each asset class in the primary investment fund (the Selected Asset Allocation column), the asset allocation percentage for each asset class in the comparison investment fund (the Comparison Asset Allocation column), and the difference between the two values.

Once the performance attribution module 108 has determined the rate of return for the comparison investment fund, the performance attribution module 108 determines (320) the opportunity set contribution value—which relates to how good a performance could have been typically expected given the lineup or set of eligible funds available to the manager, given the asset allocation decision made by the manager. To determine the opportunity set contribution value (R_{OSC}), the performance attribution module 108 uses the following algorithm:

R_{OSC}=R_{MaxEnt}−R_{effective}

where, as set forth previously, R_{MaxEnt} is the rate of return for the comparison investment fund (i.e., 4.69%) and R_{effective} is the rate of return for the selected asset allocation of the primary investment fund (i.e., 4.46%). Using these exemplary values, the opportunity set contribution value is 0.23%.

The performance attribution module 108 then retrieves (322) the actual rate of return (R_{PF}) for the primary investment fund. As provided above, the actual rate of return for the primary investment fund in the example used herein is 4.36%.

The performance attribution module 108 then determines (324) the fund selection contribution value—that is, how much value did the manager's asset selections add or subtract, compared to the previously determined asset lineup quality available to the manager. To determine the fund selection contribution value (R_{FSC}), the performance attribution module 108 uses the following algorithm:

R_{FSC}=R_{PF}−R_{MaxEnt}

where, as set forth previously, R_{PF} is the actual rate of return for the primary investment fund (i.e., 4.36%) and R_{MaxEnt} is the rate of return for the comparison investment fund (i.e., 4.69%). Using these exemplary values, the fund selection contribution value is −0.33% —meaning that the manager's selection of assets/funds in the primary investment fund actually contributed to a decrease in value, contrary to the impression one may have had that the manager did well based upon the initial determination set forth above that the primary investment fund outperformed the benchmark by 0.10%. In reality, a naïve allocation disclaiming any knowledge of the underlying assets' merits would have performed better given the asset-class constraints the manager actually put into effect.

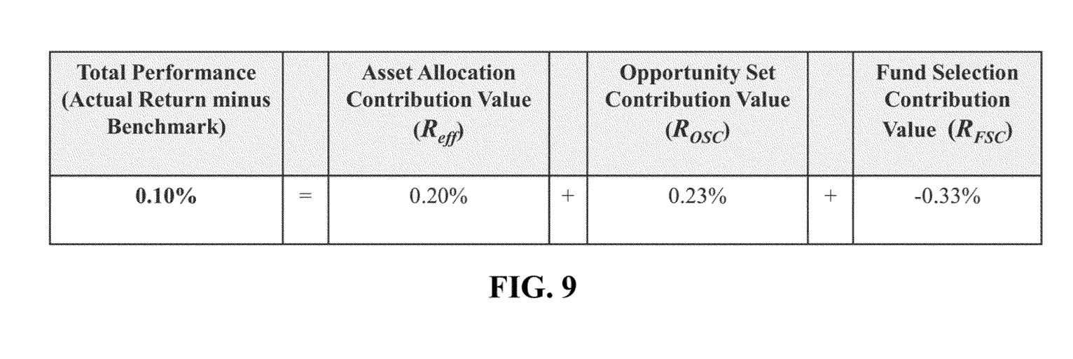

FIG. 9 is a table depicting the total performance of the investment fund based upon the asset allocation contribution value, the opportunity set contribution value and the fund selection contribution value. As shown in FIG. 9, the overall outperformance of the primary investment fund over the benchmark value (0.10%) is attributed to a 0.20% addition of value from the selected asset allocation for the primary investment fund, a 0.23% addition of value from the opportunity set (or available roster) of funds to choose from in crafting the primary investment fund, and a 0.33% subtraction of value from the fund selection undertaken by the manager of the primary investment fund. Therefore, using the methods and systems described herein, the manager's performance can be isolated and analyzed separate from the other factors that may have contributed to an investment fund's overall performance.

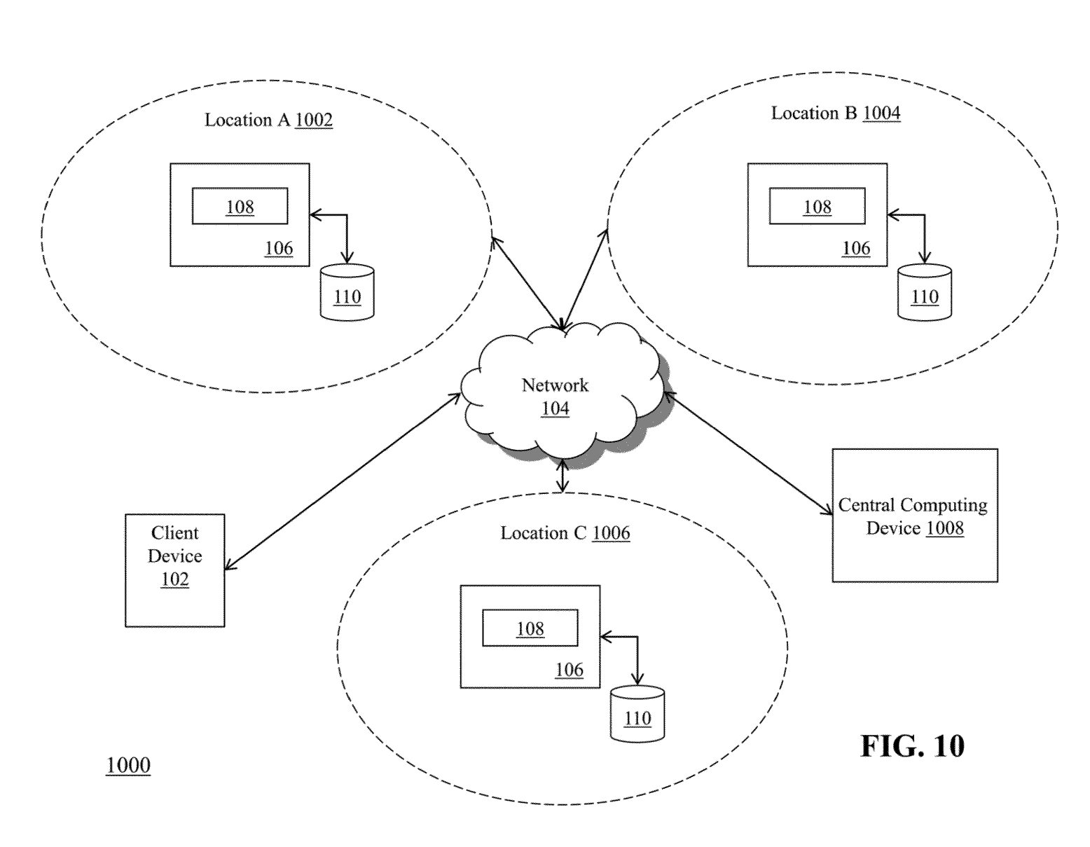

The methods, systems and techniques described herein may be implemented in a networked system 1000 comprising multiple computing devices distributed across different locations, as shown in FIG. 10. Each of Location A 1002, Location B 1004 and Location C 1006 includes the server computing device 106 having components 108, 110 of FIG. 1, and the servers at locations 1002, 1004, 1006 are connected to each other via the network 104. The networked system of FIG. 10 enables distribution of the processing functions described herein across several computing devices and provides redundancy in the event that a computing device at one location is offline or inoperable. In some embodiments, client computing devices (e.g., device 102) in proximity to a particular location (e.g., Location A 1002) access the networked system via the server 106 at that location. In some embodiments, the server computing devices 106 at the respective locations 1002, 1004, 1006 communicate with a central computing device 1008 (e.g., a server) that is coupled to the network. The central computing device 1008 can provide data and/or processing resources for the network of computing devices 106 (e.g., synchronization of functionality/data across the computing devices).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

1. A computerized method for performance attribution for a fund of funds, the method comprising:
determining, by a performance attribution module of a server computing device, a manager-selected asset allocation for a primary fund of funds based upon a manager-selected weight assigned to each asset in the primary fund of funds and asset class exposures assigned to each asset in the primary fund of funds, the assets in the primary fund of funds selected from a set of eligible assets;
determining, by the performance attribution module, a first hypothetical rate of return for the primary fund of funds based upon the manager-selected asset allocation and using returns associated with a benchmark policy of the primary fund of funds;
generating, by the performance attribution module, a comparison fund of funds, wherein the comparison fund of funds is comprised of assets from the set of eligible assets and includes a comparison weight assigned to each asset that is based at least in part upon achieving maximum diversity of assets within the set of eligible assets while maintaining an asset allocation for the comparison fund of funds that conforms to the selected asset allocation for the primary fund of funds;
determining, by the performance attribution module, a second rate of return for the comparison fund of funds based upon returns of each asset in the set of eligible assets using the comparison weight assigned to each asset;
comparing, by the performance attribution module, the second rate of return and a third rate of return for the primary fund of funds based upon an actual return of the primary fund of funds to generate a fund selection contribution value;
comparing, by the performance attribution module, the first rate of return and the second rate of return to generate an opportunity set contribution value; and
assigning, by the performance attribution module, a level of performance attributable to a manager of the primary fund of funds based upon the fund selection contribution value and the opportunity set contribution value.

2. The method of claim 1, wherein the step of determining a first hypothetical rate of return for the primary fund of funds is based upon a benchmark return value.

3. The method of claim 2, wherein the benchmark return value is based upon returns associated with one or more market indices.

4. The method of claim 2, further comprising:
determining, by the performance attribution module, a fourth rate of return for the primary fund of funds based upon the benchmark return value and an asset allocation policy associated with the primary fund of funds; and
determining, by the performance attribution module, an asset allocation contribution value based upon the first hypothetical rate of return and the fourth rate of return.

5. The method of claim 4, wherein the level of performance attributable to a manager of the primary fund of funds is further based upon the asset allocation contribution value.

6. The method of claim 5, wherein the asset allocation contribution value, the fund selection contribution value and the opportunity set contribution value are added together to arrive at the level of performance.

7. The method of claim 1, wherein the opportunity set contribution value is used to determine which assets are included in the primary fund of funds for future periods of time.

8. The method of claim 1, wherein the level of performance represents a decrease in a rate of return of the primary fund of funds that is attributable to the manager of the primary fund of funds.

9. The method of claim 1, wherein the asset allocation for the comparison fund of funds conforms to the selected asset allocation for the primary fund of funds if the asset allocation for the comparison fund of funds is within a predetermined tolerance of the selected asset allocation for the primary fund of funds.

10. The method of claim 1, further comprising transmitting, by the performance attribution module, a notice including the level of performance to a remote computing device associated with the manager of the primary fund of funds.

11. The method of claim 10, wherein the notice is transmitted to a remote computing device associated with a manager of the manager of the primary fund of funds.

12. A system for performance attribution for a fund of funds, the system comprising a server computing device having a performance attribution module configured to:
determine a selected asset allocation for a primary fund of funds upon a manager-selected weight assigned to each asset in the primary fund of funds and asset class exposures assigned to each asset in the primary fund of funds, the assets in the primary fund of funds selected from a set of eligible assets;
determine a first hypothetical rate of return for the primary fund of funds based upon the manager-selected asset allocation and using returns associated with a benchmark policy of the primary fund of funds;
generate a comparison fund of funds, wherein the comparison fund of funds is comprised of assets from the set of eligible assets, an asset allocation for the comparison fund of funds conforms to the selected asset allocation for the primary fund of funds, and the comparison fund of funds includes a comparison weight assigned to each asset that is based at least in part upon achieving maximum diversity of assets within the set of eligible assets while maintaining an asset allocation for the comparison fund of funds that conforms to the selected asset allocation for the primary fund of funds;
determine a second rate of return for the comparison fund of funds based upon returns of each asset in the set of eligible assets using the comparison weight assigned to each asset;
compare the second rate of return and a third rate of return for the primary fund of funds based upon an actual return of the primary fund of funds to generate a fund selection contribution value;
compare the first rate of return and the second rate of return to generate an opportunity set contribution value; and
assign a level of performance attributable to a manager of the primary fund of funds based upon the fund selection contribution value and the opportunity set contribution value.

13. The system of claim 12, wherein the step of determining a first hypothetical rate of return for the primary fund of funds is based upon a benchmark return value.

14. The system of claim 13, wherein the benchmark return value is based upon returns associated with one or more market indices.

15. The system of claim 13, wherein the performance attribution module is further configured to:
determine a fourth rate of return for the primary fund of funds based upon the benchmark return value and an asset allocation policy associated with the primary fund of funds; and
determine an asset allocation contribution value based upon the first hypothetical rate of return and the fourth rate of return.

16. The system of claim 15, wherein the level of performance attributable to a manager of the primary fund of funds is further based upon the asset allocation contribution value.

17. The system of claim 16, wherein the asset allocation contribution value, the fund selection contribution value and the opportunity set contribution value are added together to arrive at the level of performance.

18. The system of claim 12, wherein the opportunity set contribution value is used to determine which assets are included in the primary fund of funds for future periods of time.

19. The system of claim 12, wherein the level of performance represents a decrease in a rate of return of the primary fund of funds that is attributable to the manager of the primary fund of funds.

20. The system of claim 12, wherein the asset allocation for the comparison fund of funds conforms to the selected asset allocation for the primary fund of funds if the asset allocation for the comparison fund of funds is within a predetermined tolerance of the selected asset allocation for the primary fund of funds.

21. The system of claim 12, wherein the performance attribution module is further configured to transmit a notice including the level of performance to a remote computing device associated with the manager of the primary fund of funds.

22. The system of claim 21, wherein the notice is transmitted to a remote computing device associated with a manager of the manager of the primary fund of funds.

23. A computer program product, tangibly embodied in a non-transitory computer readable storage device, for performance attribution for a fund of funds, the computer program product including instructions operable to cause a performance attribution module of a server computing device to:
determine a selected asset allocation for a primary fund of funds upon a manager-selected weight assigned to each asset in the primary fund of funds and asset class exposures assigned to each asset in the primary fund of funds, the assets in the primary fund of funds selected from a set of eligible assets;
determine a first hypothetical rate of return for the primary fund of funds based upon the manager-selected asset allocation and using returns associated with a benchmark policy of the primary fund of funds;
generate a comparison fund of funds, wherein the comparison fund of funds is comprised of assets from the set of eligible assets, an asset allocation for the comparison fund of funds conforms to the selected asset allocation for the primary fund of funds, and the comparison fund of funds includes a comparison weight assigned to each asset that is based at least in part upon achieving maximum diversity of assets within the set of eligible assets while maintaining an asset allocation for the comparison fund of funds that conforms to the selected asset allocation for the primary fund of funds;
determine a second rate of return for the comparison fund of funds based upon returns of each asset in the set of eligible assets using the comparison weight assigned to each asset;
compare the second rate of return and a third rate of return for the primary i fund of funds based upon an actual return of the primary fund of funds to generate a fund selection contribution value;
compare the first rate of return and the second rate of return to generate an opportunity set contribution value; and
assign a level of performance attributable to a manager of the primary fund of funds based upon the fund selection contribution value and the opportunity set contribution value.
